(19) United States
(12) Patent Application Publication
(10) Pub. No.: US 2018/0339641 A1
(43) Pub. Date: Nov. 29, 2018

(54) LIGHTING CIRCUIT AND VEHICLE LAMP

(71) Applicant: Koito Manufacturing Co., Ltd., Tokyo (JP)

(72) Inventors: Kotaro Matsui, Shizuoka-shi (Shizuoka) (JP); Takao Sugiyama, Shizuoka-shi (Shizuoka) (JP)

(21) Appl. No.: 15/979,922

(22) Filed: May 15, 2018

(30) Foreign Application Priority Data
May 24, 2017 (JP) 2017-102907

(51) Int. Cl. B60Q 1/00; H05B 33/08

(52) U.S. Cl. CPC B60Q 1/0076; H05B 33/0815

(57) ABSTRACT

A light source includes a first light emitting unit, which performs light emission of a first function, and a second light emitting unit, which performs light emission of a second function and has the maximum lighting voltage lower than the forward voltage of the first light emitting unit, the first light emitting unit and the second light emitting unit being connected in parallel to each other. A lighting circuit includes a current supply unit, which supplies driving current to the light source, a controller, which performs stabilization control of the driving current from the current supply unit, a switch element, which is provided to disconnect a current path portion, which is the current path of the second light emitting unit and is parallel to the current path of the first light emitting unit, and a selector, which connects the current path of the second light emitting unit by the switch element when light emission of the second function is performed.

### CROSS-REFERENCE TO RELATED APPLICATIONS

This application is based on and claims priority from Japanese Patent Application No. 2017-102907 filed on May 24, 2017 with the Japan Patent Office, the disclosure of which is incorporated herein in its entirety by reference.

### TECHNICAL FIELD

The present disclosure relates to a lighting circuit for a light source that performs light emission of a plurality of functions and a vehicle lamp having the lighting circuit.

### BACKGROUND

Various lamps, such as, for example, a vehicle lamp using a semiconductor light emitting element such as, for example, a light emitting diode (LED) is known.

In addition, as vehicle lamps, lamps of various functions such as, for example, a head lamp, a daytime running lamp (DRL), a clearance lamp (CLL), a turn signal lamp, a tail lamp, and a stop lamp are implemented using a semiconductor light emitting element, and, for example, the amount of light and the light distribution state of each lamp are designed according to the function thereof.

Japanese Patent Laid-Open Publication No. 2010-015275 discloses a lighting control device that controls the lighting-on of a plurality of lamp units having different functions.

### SUMMARY

In some cases, respective light emitting elements of a plurality of functions may be exclusively driven by one lighting circuit.

For example, in a vehicle lamp having a light source and a lighting circuit, the light source includes a light source unit as a DRL and a light source unit as a CLL, and the lighting circuit is a component that selectively supplies driving current to the light source units. In this case, for example, it is considered to adopt a configuration in which switches are disposed respectively in the driving current path of the DRL and the driving current path of the CLL, and are selectively turned on.

However, as such a configuration for selectively driving a plurality of light sources having different light emitting functions using a common lighting circuit, a simpler and more efficient configuration is required.

Accordingly, the present disclosure proposes a method capable of realizing a more efficient circuit configuration in a case where light emission of a first function and light emission of a second function are exclusively performed by a lighting circuit.

### DETAILED DESCRIPTION

A lighting circuit according to the present disclosure includes a current supply unit configured to supply driving current to a light source in which a first light emitting unit configured to perform light emission of a first function and a second light emitting unit configured to perform light emission of a second function and having a maximum lighting voltage lower than a forward voltage of the first light emitting unit are connected in parallel to each other, a switch element provided to connect and disconnect a portion of a current path of the second light emitting unit, which is parallel to a current path of the first light emitting unit, and a selector configured to connect the current path of the second light emitting unit by the switch element when the light emission of the second function is performed.

In the light source, the first light emitting unit configured with, for example, one or more LEDs and the second light emitting unit configured with, for example, one or more LEDs are connected in parallel to each other. Stabilized driving current is supplied from the lighting circuit to the light source. In this case, on the assumption of a configuration in which the maximum lighting voltage of the second light emitting unit is lower than the forward voltage of the first light emitting unit, the switch element is disposed in the current path of the second light emitting unit so as to perform switching of light emission between the first light emitting unit and the second light emitting unit.

In the lighting circuit, it is considered that the lighting circuit has a capacitor connected to a gate terminal or a base terminal of the switch element and configured to slow down a turn-on speed of the switch element.

When the switch element is turned on, large current flows to the second light emitting unit. Thus, the turn-on period of the switch element is prolonged.

In the lighting circuit, it is considered that the selector performs control such that a current value of the driving current varies between a case of performing the light emission of the first function and a case of performing the light emission of the second function.

The controller switches stabilization target current in response to the determination of the selector as to the first function or the second function.

In the lighting circuit, it is considered that a first signal and a second signal are respectively supplied, and that the selector connects the current path of the second light emitting unit by the switch element during a period in which the second signal is supplied.

That is, the selector performs a process of turning on the switch element by detecting only the supply of the second signal.

According to the present disclosure, a simpler and more efficient configuration may be realized as a configuration in which a plurality of light source units having different light emitting functions are selectively driven by a common lighting circuit.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a circuit diagram of a first exemplary embodiment of the present disclosure.

FIG. 2 is a block diagram of a configuration of a controller according to the exemplary embodiment.

FIGS. 3A and 3B are explanatory diagrams of function switching control according to the exemplary embodiment and a comparative example.

FIG. 4 is a circuit diagram of the comparative example.

FIGS. 5A and 5B are explanatory diagrams of the current-voltage characteristics of a light source unit according to the exemplary embodiment.

FIG. 6 is a circuit diagram of a second exemplary embodiment.

FIG. 7 is a circuit diagram of a third exemplary embodiment.

### DESCRIPTION OF EMBODIMENT

### First Exemplary Embodiment

Hereinafter, a vehicle lamp according to an exemplary embodiment will be described with reference to the drawings.

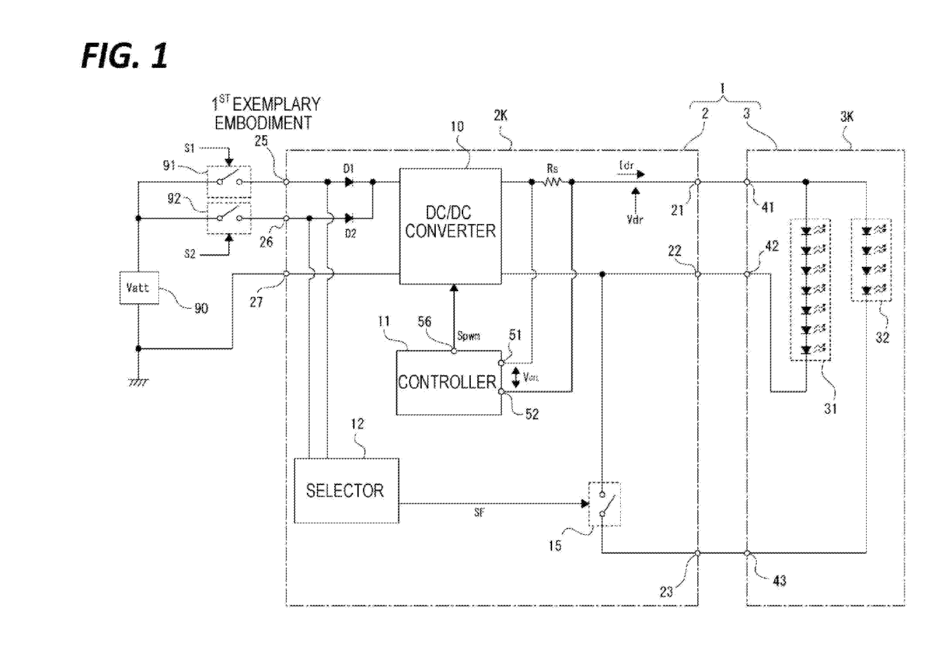

As illustrated in FIG. 1, a vehicle lamp 1 according to the exemplary embodiment includes a lighting circuit 2 and a light source 3.

The vehicle lamp 1 drives a light emitting unit having a first function (first light emitting unit 31) and a light emitting unit having a second function (second light emitting unit 32) by the common lighting circuit 2 to emit light. For example, it is assumed that the first function is a “DRL” function, and the second function is a “CLL” function. In addition, the two functions are not limited to the “DRL” and “CLL” functions, and for example, a DRL and a turn signal lamp having the same light emitting surface are considered. That is, any combination of light emitting functions may be used so long as light emitting elements are separate from each other and emit light exclusively.

The lighting circuit 2 is configured with various electronic components disposed on, for example, a drive substrate 2K.

In addition, the light source 3 is formed to have one or more light emitting elements disposed on a light source substrate 3K, which is a substrate different from the above-described drive substrate 2K. Here, as an example using an LED as the light emitting element, an example in which the first light emitting unit 31 performs light emission as a DRL by connecting seven LEDs in series and the second light emitting unit 32 performs light emission as a CLL by connecting four LEDs in series will be described. Of course, this is merely an example, and various numbers of LEDs of the first light emitting unit 31 and the second light emitting unit 32 are considered, and various serial or parallel connection configurations are considered when a plurality of light emitting elements are used.

In the light source 3, the respective LEDs as the first light emitting unit 31 are connected between terminals 41 and 42 provided on the light source substrate 3K. In addition, the respective LEDs as the second light emitting unit 32 are connected between the terminals 41 and 43.

The terminals 42 and 43 are respectively connected to the negative electrode line of a DC/DC converter 10 of the lighting circuit 2. Thus, in the light source 3, the first light emitting unit 31 and the second light emitting unit 32 are connected in parallel to each other. Then, each of the first light emitting unit 31 and the second light emitting unit 32 is driven to emit light when driving current Idr, which is constant current controlled, is supplied thereto from the lighting circuit 2.

The lighting circuit 2 is configured to receive power supplied from a battery 90 of a vehicle at a position between a terminal 25 or a terminal 26 and a terminal 27, which are provided on the drive substrate 2K.

A first switch 91 is inserted between a positive electrode terminal of the battery 90 and the terminal 25 of the lighting circuit 2, and a second switch 92 is inserted between the positive electrode terminal of the battery 90 and the terminal 26 of the lighting circuit 2.

The terminal 27 of the drive substrate 2K is connected to the negative electrode side of the battery 90 via a grounding point.

The first switch 91 is a switch that turns on the first function by a signal S1. Assuming the “DRL” function as the first function, the first switch 91 is turned on by the signal Si in response to, for example, the ignition-on of the vehicle.

The second switch 92 is a switch that turns on the second function by a signal S2. Assuming the “CLL” function as the second function, the second switch 92 is turned on by the signal S2 in response to, for example, a vehicle width lamp lighting operation of an occupant (or an automatic vehicle width lamp lighting control of the vehicle).

In addition, the first function and the second function are exclusively executed. The DRL lighting is executed in response to the ignition-on, but is switched to the CLL lighting even in the state of the ignition-on in response to the vehicle width lamp lighting. Thus, for example, when both the first switch 91 and the second switch 92 are turned on, the second function has priority.

As described above, the lighting-on/off of the vehicle lamp 1 and the selection of the functions are controlled by the on and off of the first switch 91 and the second switch 92.

In addition, although not illustrated, the lighting circuit 2 may be configured to be communicatively connected to an electronic control unit (ECU) that performs electrical control on the vehicle side. In that case, a configuration is also considered which allows a power supply voltage line and a ground line from the battery 90 to be connected to the terminals 25, 26, and 27 via the ECU and allows the ECU to control power supply to the lighting circuit 2.

In the lighting circuit 2, a battery voltage supplied to the terminals 25 and 26 is applied to the DC/DC converter 10 via a diode-OR circuit formed by diodes D1 and D2.

The DC/DC converter 10 is a current supply unit that supplies the driving current Idr to the LED 31 of the light source 3.

The DC/DC converter 10 is, for example, a switching regulator. Any of a step-up type, a step-down type, and a step-up and step-down type is considered for the DC/DC converter 10, although the type of the DC/DC converter 10 is determined depending on a relationship between a light source configuration (e.g., a forward drop voltage) of the light source 3 and a power supply voltage by the battery 90.

The DC/DC converter 10 performs voltage conversion by receiving a DC voltage from the battery 90, and generates an output voltage Vdr. The output voltage Vdr appears between the terminals 21 and 22, provided on the drive substrate 2K, via a current detection resistor Rs.

Between the drive substrate 2K and the light source substrate 3K, a harness interconnects the terminal 21 and the terminal 41, the terminal 22 and the terminal 42, and the terminal 23 and the terminal 43.

Therefore, the driving current Idr, which is based on the output voltage Vdr appearing on the output side of the DC/DC converter 10, flows in a current path of the terminal 21→the terminal 41→the first light emitting unit 31→the terminal 42→the terminal 22, or in a current path of the terminal 21→the terminal 41→the second light emitting unit 32→the terminal 43→the terminal 23.

In addition, the terminal 22 is connected to the negative electrode line of the DC/DC converter 10, and the terminal 23 is connected to the negative electrode line of the DC/DC converter 10 via a switch element 15.

A controller 11 causes the DC/DC converter 10 to perform a voltage conversion operation, and also performs the constant current control of the driving current Idr.

For example, the controller 11 detects a current value of the driving current Idr based on the result of detecting the potential difference (control target voltage VCTL) between one end and the other end of the current detection resistor Rs with two terminals 51 and 52. Then, the controller 11 compares the detected current value of the driving current Idr with a target current value, and generates a switching control signal Spwm, which is a PWM signal depending on the difference. The controller 11 supplies the switching control signal Spwm from a terminal 56 to a switching element of a switching converter, which is the DC/DC converter 10, to control the voltage conversion operation, thereby realizing constant current output.

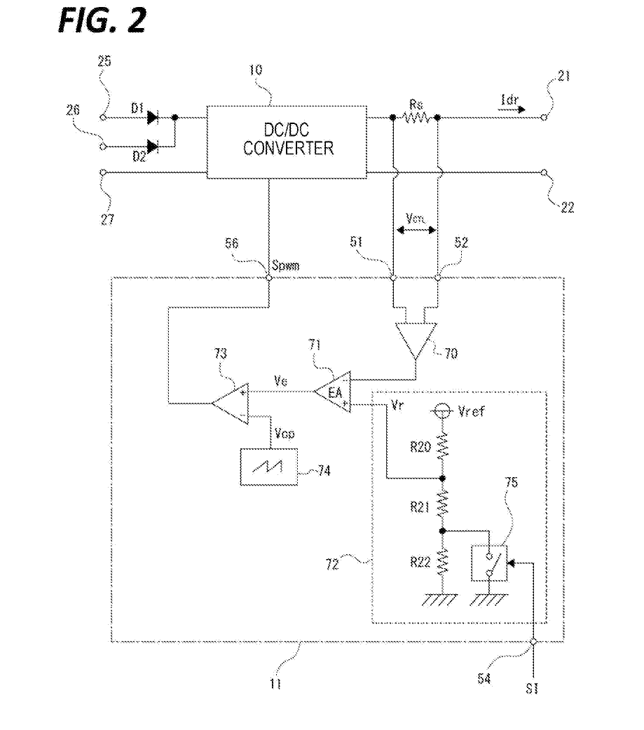

A schematic configuration example of such a controller 11 is illustrated in FIG. 2.

The controller 11 detects the voltage difference across the current detection resistor Rs (control target voltage VCTL) by a current detection amplifier 70. An error amplifier 71 obtains an error signal Ve by taking the difference between the control target voltage VCTL and a reference voltage Vr generated by a reference voltage generator 72.

Although the drawing illustrates a configuration in which the reference voltage generator 72 includes resistors R20, R21 and R22 and a switch 75, the reference voltage generator 72 is configured to vary a reference voltage according to a third exemplary embodiment, and will be described below. In a case of the first exemplary embodiment, the reference voltage generator 72 may obtain a certain fixed reference voltage Vr.

The error signal Ve from the error amplifier 71 is compared with a comparison signal Vcp generated in a comparison signal generator 74 by an error comparator 73. The comparison signal Vcp is, for example, a sawtooth wave signal. Therefore, the switching control signal Spwm with a pulse duty depending on a current error amount may be obtained from the error comparator 73. The switching control signal Spwm is output from the terminal 56 to the DC/DC converter 10, and the switching element of the DC/DC converter 10 is controlled to be turned on or off, whereby stabilization of output current is promoted.

Returning to FIG. 1, in the lighting circuit 2, the terminal 26 is connected to a selector 12. The selector 12 performs detection of a voltage value of the terminal 26, thereby determining whether or not the lighting-on of the second function is currently instructed. Then, the switch element 15 is controlled to be turned on or off by a switching control signal SF based on the determined result.

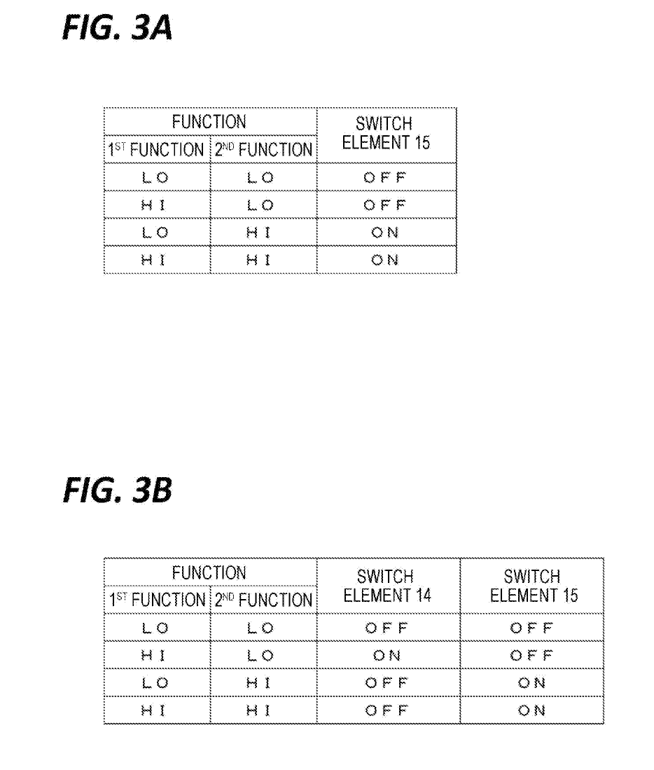

FIG. 3A illustrates the ON/OFF state of the switch element 15 by the switching control signal SF. “LO” and “HI” as the first function indicate whether the terminal voltage of the terminal 25 is a low level or a high level. “LO” and “HI” as the second function indicate whether the terminal voltage of the terminal 26 is a low level or a high level.

The selector 12 turns on or off the switch element 15 in response to the voltage of the terminal 26 on the second function side.

That is, the selector 12 turns off the switch element 15 by the switching control signal SF during the period in which no power supply voltage is supplied to the terminal 26 and the voltage of the terminal 26 is “LO”, that is, during the period in which the lighting-on of the second function is not instructed. At this time, light is emitted from the first light emitting unit 31 when a power supply voltage is supplied to the terminal 25, and both the first light emitting unit 31 and the second light emitting unit 32 are turned off when no power supply voltage is supplied to the terminal 25.

In addition, the selector 12 turns on the switch element 15 by the switching control signal SF during the period in which a power supply voltage is supplied to the terminal 26 and the voltage of the terminal 26 is “HI”, that is, during the period in which the lighting-on of the second function is instructed. Thereby, the second light emitting unit 32 emits light. In addition, at this time, the first light emitting unit 31 is turned off even if a power supply voltage is supplied to the terminal 25.

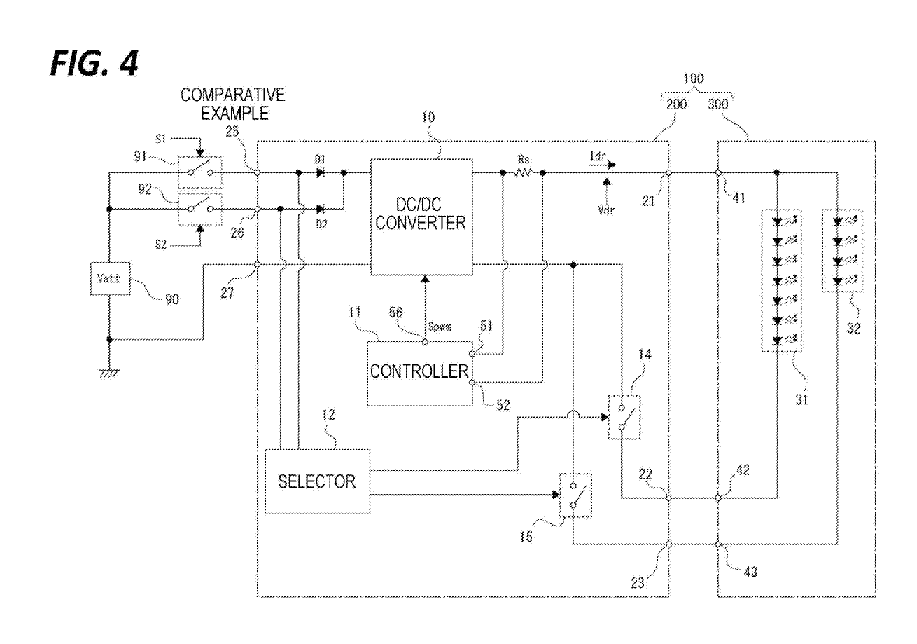

Here, in order to explain the effect of the configuration of the first exemplary embodiment, a comparative example will be considered. FIG. 4 illustrates a vehicle lamp 100 having a lighting circuit 200 and a light source 300 as a comparative example. In addition, in the comparative example and the exemplary embodiment to be described below, the circuit constituent elements similar to those in FIG. 1 will be denoted by the same reference numerals, a repeated description thereof will be omitted, and only different elements will be described.

In the comparative example of FIG. 4, a switch element 14 is provided between the terminal 22 and the negative electrode line of the DC/DC converter 10, and the switch element 15 is provided between the terminal 23 and the negative electrode line of the DC/DC converter 10. That is, in this example, in order to selectively cause the first light emitting unit 31 and the second light emitting unit 32 to emit light, the switch elements 15 and 14 are provided independently of each other.

In this case, the selector 12 controls the switch elements 14 and 15, as illustrated in FIG. 3B. Control of the switch element 15 is the same as that of FIG. 3A, and the switch element 15 is turned off when the terminal 26 on the second function side is “LO”, and is turned on when the terminal 26 on the second function side is “HI”.

On the other hand, the switch element 14 is controlled such that the switch element 14 is turned off when the terminal 25 on the first function side is “LO” and is turned on when the terminal 25 on the first function side is “HI”, but is turned off when both the terminal 25 and the terminal 26 are “HI”. This is to give priority to the second function.

In a case of causing the first light emitting unit 31 and the second light emitting unit 32 to selectively emit light, the configuration of this comparative example is assumed. However, the configuration of the first exemplary embodiment of FIG. 1 is simpler and less costly than the comparative example.

That is, in a case of the configuration of FIG. 1, the switch element 14 is unnecessary. In addition, the switch element 15 only needs to be controlled in response to the voltage of the terminal 26, and a configuration thereof is simplified.

Then, the light emission of the first light emitting unit 31 and the second light emitting unit 32 may be switched.

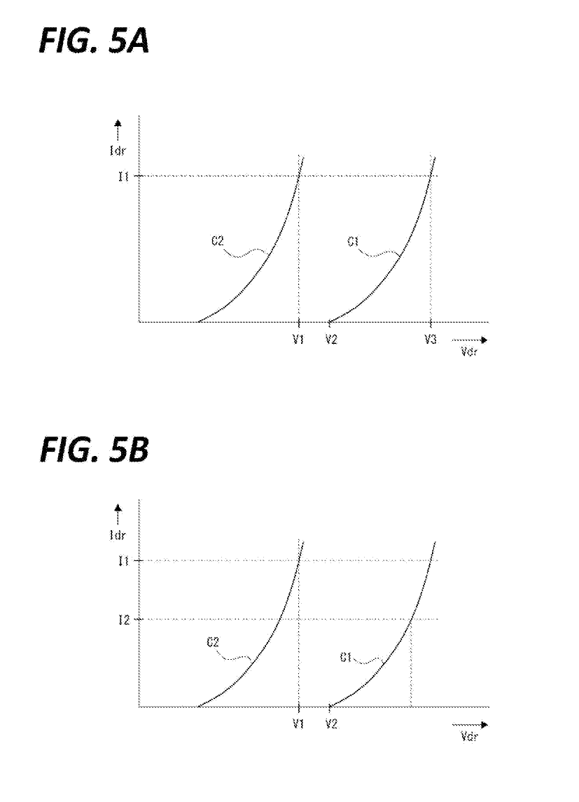

In FIG. 5A, the vertical axis represents the driving current Idr, and the horizontal axis represents the output voltage Vdrm. FIG. 5A illustrates the voltage-current curve C1 of the first light emitting unit 31 and the voltage-current curve C2 of the second light emitting unit 32.

The current I1 is the rated current in a case of the second function. The voltage V1 is the maximum lighting voltage of the second light emitting unit 32, the voltage V2 is the minimum lighting voltage (forward voltage) of the first light emitting unit 31, and the voltage V3 is the voltage that is applied to the first light emitting unit 32 when the driving current Idr is equal to the current I1.

That is, in the case of the present exemplary embodiment, the maximum lighting voltage V1 of the second light emitting unit 32 is lower than the forward voltage V2 of the first light emitting unit 31. As such, all the driving current Idr flows to the LED of the second light emitting unit 32 even in a state where the switch element 15 is turned on. Therefore, the switch element 14 as in the comparative example may be unnecessary.

Specifically, since the current path of the second light emitting unit 32 is disconnected during the period in which the switch element 15 is turned off, all the driving current Idr flows to the first light emitting unit 31. In both cases of the first function and the second function, assuming that stabilization control is performed so that the driving current Idr is equal to the current I1, the output voltage of the DC/DC converter 10 becomes the voltage V3, the driving current Idr becomes the current I1, and the first light emitting unit 31 emits light, by the control of the controller 11.

Here, when the switch element 15 is turned on, the current path of the second light emitting unit 32 is formed in parallel with the first light emitting unit 31. At this time, the driving current Idr flows to the side of the second light emitting unit 32 in which the forward voltage is low. Then, by the stabilization control of the controller 11, the output voltage Vdr of the DC/DC converter 10 is lowered from the voltage V3 to the voltage V1, and the driving current Idr becomes the current I1.

In this case, since no driving current Idr flows through the first light emitting unit 31, there occurs switching to light emission of the second light emitting unit 32.

In this manner, under a condition in which the maximum lighting voltage V1 of the second light emitting unit 32 is lower than the minimum lighting voltage V2 of the first light emitting unit 31, switching between light emission of the first function and light emission of the second function may be realized by turning on and off only the switch element 15.

Therefore, according to the first exemplary embodiment, a configuration of the lighting circuit 2 may be simplified, compared to that in the comparative example.

### Second Exemplary Embodiment

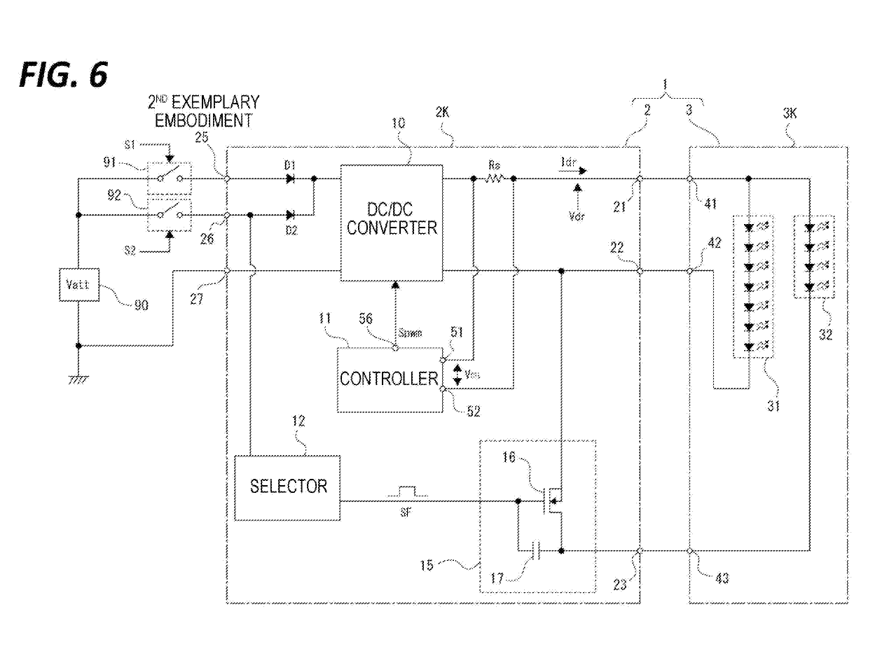

FIG. 6 illustrates the vehicle lamp 1 according to the second exemplary embodiment. Here, as an example of the switch element 15 in the first exemplary embodiment of FIG. 1, an N-channel metal oxide semiconductor-field effect transistor (MOS-FET) 16 is illustrated.

In addition, a capacitor 17 for slow switching is connected between the drain and the gate of the MOS-FET 16.

The switching control signal SF from the selector 12 is a high-level or low-level signal. Here, when the switching control signal SF is switched from the low level to the high level, the rise of the gate voltage of the MOS-FET 16 is delayed by the capacitor 17. In other words, a certain period of time may be obtained, during which the MOS-FET 16 is in a transient state (a state in which a resistance value occurs) from the OFF state to the ON state thereof. That is, the turn-on speed becomes slow.

Thus, it is possible to prevent large current from flowing to the second light emitting unit 32 at the moment when the switch element 15 is controlled to be turned on.

Upon switching from light emission of the first light emitting unit 31 to light emission of the second light emitting unit 32, the output voltage Vdr of the DC/DC converter 10 falls from the voltage V3 to the voltage V1 of FIG. 5A, for example. At this time, depending on, for example, the responsiveness of stabilization control or the difference in the output voltage Vdr between the first function and the second function, the driving current Idr, which becomes large current, may instantaneously flow to the second light emitting unit 32 at a point in time at which the output voltage does not completely fall to the voltage V1. Thus, the capacitor 17 is used to lengthen the turn-on time of the MOS-FET 16 so as to prevent such overcurrent.

### Third Exemplary Embodiment

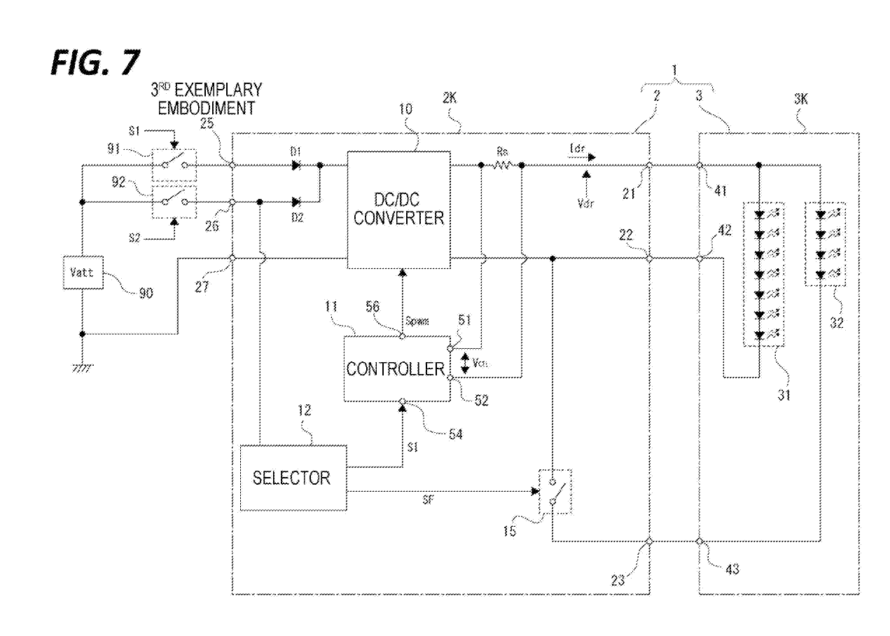

A third exemplary embodiment will be described with reference to FIG. 7. The lighting circuit 2 according to the third exemplary embodiment is an example in which the selector 12 supplies the current control signal SI a terminal 54 of the controller 11 in response to the presence or absence of an instruction of light emission of the second function (application of a power source voltage to the terminal 26).

The controller 11 includes the reference voltage generator 72 illustrated in FIG. 2.

As illustrated in FIG. 2, in the reference voltage generator 72, the resistors R20, R21, and R22 are connected in series between a voltage Vref and a ground. In addition, the voltage at a connection point of the resistors R20 and R21 is supplied as the reference voltage Vr to the error amplifier 71.

In addition, the switch 75 is connected between a connection point of the resistors R21 and R22 and the ground. The switch 75 is turned on and off by the current control signal SI supplied to the terminal 54.

In this case, the selector 12 controls the switch element 15 to be turned off by the switching control signal SF and the switch 75 to be turned on by the current control signal SI during the period in which a power supply voltage is not detected at the terminal 26 (when there is no instruction of light emission of the second function).

In addition, when a power supply voltage is detected at the terminal 26 (when light emission of the second function is instructed), the selector 12 controls the switch element 15 to be turned on by the switching control signal SF and the switch 75 to be turned off by the current control signal SI. Thereby, the reference voltage Vr in the second function is higher than that in the first function.

As described above, in the light emission of the first function and the second function, the stabilization control is performed to vary the driving current Idr by varying the reference voltage Vr.

For example, FIG. 5B illustrates the voltage-current curve C1 of the first light emitting unit 31 and the voltage-current curve C2 of the second light emitting unit 32, as in FIG. 5A, but control is performed so that the driving current Idr is equal to the current I2 upon light emission of the first light emitting unit 31, and so that the driving current Idr is equal to the current I1 upon light emission of the second light emitting unit 32.

In contrast to the above example, an example is considered in which the selector 12 turns on the switch 75 by the current control signal SI when a power supply voltage is detected at the terminal 26. Thereby, the reference voltage Vr in the second function becomes lower than that in the first function, and for example, control is performed to suppress the current value of the driving current Idr in the second function, compared to that in the first function.

In the above example, the driving voltage Idr is varied by adjusting the reference voltage Vr, but a plus offset or a minus offset may be given to the comparison signal Vcp generated by the comparison signal generator 74, or a plus offset or a minus offset may be given to the control target voltage VCTL or the error signal Ve, in response to the current control signal SI.

In addition, the above method is an example in which the output current of the DC/DC converter 10 is lowered in a DC manner, but it is considered to give, as the current control signal SI for the controller 11, a PWM signal for the ON/OFF control of an operation of the DC/DC converter 10 and to vary the average current of the DC/DC converter 10 by the duty ratio thereof.

### Summary and Modification

In each of the above exemplary embodiments, the lighting circuit 2 includes the current supply unit 10, which supplies the driving current to the light source 3 in which the first light emitting unit 31, which performs light emission of a first function, and the second light emitting unit 32, which performs light emission of the second function and has the maximum lighting voltage V1 lower than the forward voltage (the minimum lighting voltage V2) of the first light emitting unit 31, are connected in parallel to each other. In addition, the lighting circuit 2 includes the controller 11, which performs stabilization control of the driving current Idr from the current supply unit 10, the switch element 15, which is provided to connect and disconnect a portion of the current path of the second light emitting unit 32 which is in parallel with the current path of the first light emitting unit 31, and the selector 12, which connects the current path of the second light emitting unit 32 by the switch element 15 when light emission of the second function is performed.

In this case, when the switch element 15 is turned on, the path of the driving current Idr from the DC/DC converter 10 becomes a state where both the current path of the first light emitting unit 31 and the current path of the second light emitting unit 32 are connected in parallel to each other. However, since the maximum lighting voltage of the second light emitting unit 32 is lower than the forward voltage of the first light emitting unit 31, the driving current Idr flows to the second light emitting unit 32 and does not flow to the first light emitting unit 31. That is, light emission of the second function is performed. Of course, when the switch element 15 is turned off, the driving current Idr flows only to the first light emitting unit 31, and light emission of the first function is performed. Thus, switching of light emission between the first function and the second function is enabled by a single ON/OFF switch using, for example, an FET.

In addition, since it is sufficient to monitor only the light emission of the second function, a configuration for monitoring the function of the selector 12 is also simplified.

By these, the circuit configuration of the lighting circuit may be simplified, and a reduction in the cost by this may be realized.

The second exemplary embodiment illustrates an example in which, as the switch element 15, the capacitor 17 is provided to slow down the turn-on speed of the MOS-FET 16 disposed in the current path of the second light emitting unit 32.

That is, the capacitor 17 is connected between the gate and the source of the MOS-FET 16, and the rise of the switching control signal SF is made to be gentle, whereby the turn-on period is prolonged. Thereby, it is possible to prevent the switch element 15 from being instantaneously turned on, thereby preventing excessive current from flowing to the second light emitting unit.

In addition, the switch element is not limited to the exemplified MOS-FET, but a junction type FET, a bipolar transistor and other elements may be applied. In a case of a bipolar transistor, a capacitor is connected to a base to slow down the turn-on speed.

The third exemplary embodiment illustrates an example in which the selector 12 supplies the current control signal SI to the controller 11 so that the current value of the driving current Idr is varied between a case of performing light emission of the first function and a case of performing light emission of the second function.

A configuration in which the controller varies the current value of the driving current Idr depending on the function by switching stabilization target current in response to whether the selector determines the first function or the second function may be easily realized.

The first, second, and third exemplary embodiments illustrate the configuration in which a first signal (power supply voltage for the first function) and a second signal (power supply voltage for the second function) are supplied respectively to the terminals 25 and 26. Then, the selector 12 connects the current path of the second light emitting unit 32 by the switch element 15 during the period in which the second signal is supplied. That is, the selector 12 performs a process of turning on the switch element 15 by detecting only the supply of the second signal.

Thus, the selector 12 has a very simplified configuration by simply monitoring the voltage of the terminal 26 and turning on the switch element 15 when a predetermined power supply voltage is detected.

In addition, even when the power supply voltage is supplied to both the terminal 25 and the terminal 26, by giving priority to the second function, it is possible to accurately control the switch element 15 regardless of the first signal (power supply voltage for the first function).

The respective exemplary embodiments have described an example in which the first function is light emission as a daytime running lamp and the second function is light emission as a clearance lamp.

In addition to this, a case where the first function is light emission as a stop lamp and the second function is light emission as a tail lamp is also considered.

That is, the present disclosure is useful with respect to two functions of performing light emission having a light quantity difference.

The present disclosure is not limited to the configuration of the above exemplary embodiments, and various modifications are considered.

Specific configurations and operations of, for example, the lighting circuit 2, the DC/DC converter 10, the controller 11, the selector 12, and the switch element 15 are not limited to the above examples.

The light emitting element is not limited to an LED, but a laser diode or the like is also assumed.

A configuration in which the drive substrate 2K and the light source substrate 3K are separate from each other is exemplified, but a configuration in which the lighting circuit 2 and the light source 3 are arranged on one substrate is also considered.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A lighting circuit comprising:
a current supply unit configured to supply driving current to a light source in which a first light emitting unit configured to perform light emission of a first function and a second light emitting unit configured to perform light emission of a second function and having a maximum lighting voltage lower than a forward voltage of the first light emitting unit are connected in parallel to each other;
a switch element provided to connect and disconnect a portion of a current path of the second light emitting unit, which is parallel to a current path of the first light emitting unit; and
a selector configured to connect the current path of the second light emitting unit by the switch element when the light emission of the second function is performed.

2. The lighting circuit of claim 1, further comprising a capacitor connected to a gate terminal or a base terminal of the switch element and configured to slow down a turn-on speed of the switch element.

3. The lighting circuit of claim 2, wherein the selector performs control such that a current value of the driving current varies between a case of performing the light emission of the first function and a case of performing the light emission of the second function.

4. The lighting circuit of claim 1, wherein the selector performs control such that a current value of the driving current varies between a case of performing the light emission of the first function and a case of performing the light emission of the second function.

5. The lighting circuit of claim 1, wherein a first signal and a second signal are respectively supplied, and
the selector connects the current path of the second light emitting unit by the switch element during a period in which the second signal is supplied.

6. The lighting circuit of claim 2, wherein a first signal and a second signal are respectively supplied, and
the selector connects the current path of the second light emitting unit by the switch element during a period in which the second signal is supplied.

7. The lighting circuit of claim 3, wherein a first signal and a second signal are respectively supplied, and
the selector connects the current path of the second light emitting unit by the switch element during a period in which the second signal is supplied.

8. The lighting circuit of claim 4, wherein a first signal and a second signal are respectively supplied, and
the selector connects the current path of the second light emitting unit by the switch element during a period in which the second signal is supplied.

9. A vehicle lamp comprising a light source and the lighting circuit of claim 1.
